(19) United States
(12) Patent Application Publication
(10) Pub. No.: US 2016/0363275 A1
(43) Pub. Date: Dec. 15, 2016

(54) RECHARGABLE POWER CONTAINER CONTAINING A LIGHT SOURCE

(71) Applicant: Michael Davis, Hercules, CA (US)

(72) Inventor: Michael Davis, Hercules, CA (US)

(21) Appl. No.: 14/737,932

(22) Filed: Jun. 12, 2015

(51) Int. Cl. F21L 4/08; H02J 7/00; H02J 7/35; F21V 23/00; F21V 21/22

(52) U.S. Cl. CPC F21L 4/08; F21V 23/003; F21V 21/22; H02J 7/35; H02J 7/0052; H02J 2007/0062

(57) ABSTRACT

A rechargeable power container containing a light source, power networking and connectors for powering and recharging portable devices is disclosed.

### CROSS-REFERENCE TO RELATED APPLICATIONS

This application claims the benefit of and priority to the following U.S. Provisional Patent Application No. 62/013,368 filed Jun. 17, 2014, which is incorporated herein by reference in its entirety.

### TECHNICAL FIELD OF THE INVENTION

The invention relates generally to rechargeable power containers and specifically to solar rechargeable power containers containing a light source, power networking and connectors for powering and recharging portable devices. The invention has additional space for storage of usage specific items, such as food, water and/or water purifiers, radios, emergency beacons, tools, etc., as the need arises. Additionally, the invention describes and enables methods of connecting multiple instances of the invention together to expand the capabilities and functionality of the invention.

### BACKGROUND OF THE INVENTION

There are many inhabited regions in the world with no power or communications infrastructure, and are only accessible by off road vehicle, helicopter, or by foot. There are no integrated products on the market that are small enough and cost effective enough to provide consistent power to all residents in communities with limited access.

There are no other solar rechargeable power containers with sufficient battery life and with a suitable form factor (bucket) that are light weight enough to be transported over long distances on foot and have the durability and weight distribution to be air-dropped. Other solar rechargeable power containers are either; too heavy, too fragile, the form factors are awkward, the weight distribution is not symmetrically balanced, or some combination of the aforementioned issues, which makes the portability index very low. Those solar rechargeable power containers that are feasible to carry (less than 20 lbs.) over long distances do not have sufficient battery life and features to light a home and charge a multitude of devices. Furthermore, the current offerings in the space don't have the ability to be combined with like systems to scale up the power output.

### BRIEF SUMMARY OF THE INVENTION

The invention described below improves the cost to benefit ratio by providing sufficient, rechargeable power that has a shelf life of several years, with a light sufficient to light a large room rather than just a workspace, the ability to charge USB devices and run 12 volt accessory appliances, while minimizing weight and cost to manufacture. Additionally, the invention provides the ability to combine multiple solar rechargeable power containers together to create a high-wattage power source in minutes.

### BRIEF DESCRIPTION OF THE DRAWINGS

FIG. 1 illustrates a perspective view of the power container without the lid, showing the hidden components of the power container.

FIG. 2 illustrates a top perspective view of the power container without the lid.

FIG. 3A illustrates a top perspective view of the power container lid, showing the hidden solar panel component.

FIG. 3B illustrates a bottom perspective view of the power container lid, showing the solar panel component.

FIG. 4 illustrates a side perspective view of the power container with the lid installed, showing the hidden components of the power container.

FIG. 5 illustrates a side perspective view of the power container with the lamp extended and the lid being used to recharge the power container.

### DETAILED DESCRIPTION

An embodiment of a rechargeable power container containing a light source is described. In the following description, numerous specific details are set forth. However, it is understood that embodiments may be practiced without these specific details. In other instances, well-known circuits, structures, and techniques have not been shown in detail in order not to obscure the understanding of this description.

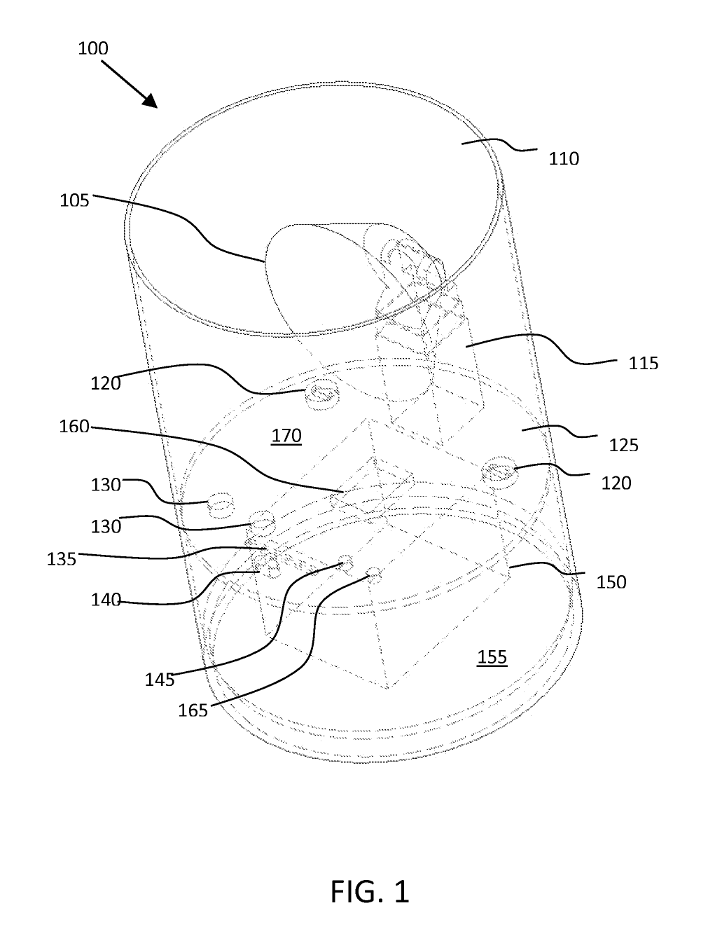

Referring to FIG. 1, which illustrates a perspective view of the power container 100 without the lid and showing the hidden components of the power container. In the preferred embodiment of the invention, the power container 100 comprises a rechargeable battery 150 attached to the bottom plate 155 of the power container 100, a number of USB powered plugs 120, a main power on/off switch 140, a number of power jacks 130, a power reserve indicator 135, an extendable lamp arm 115, a lamp assembly 105, a sealed top plate 170 to provide mechanical support for the plugs, switches, indicators, extendable lamp arm, etc., a push button switch 145 to increase the lamp intensity, a push button switch 165 to decrease the lamp intensity and an electronics module 160 to control the charging/discharging of the battery 150, controlling the intensity of the lamp assembly 105, regulating the DC voltage for the USB powered plugs 120, monitoring the battery 150 voltage reserve, indicating the battery 150 voltage reserve on the power reserve indicator 135 and providing short-circuit protection for the power jacks 130.

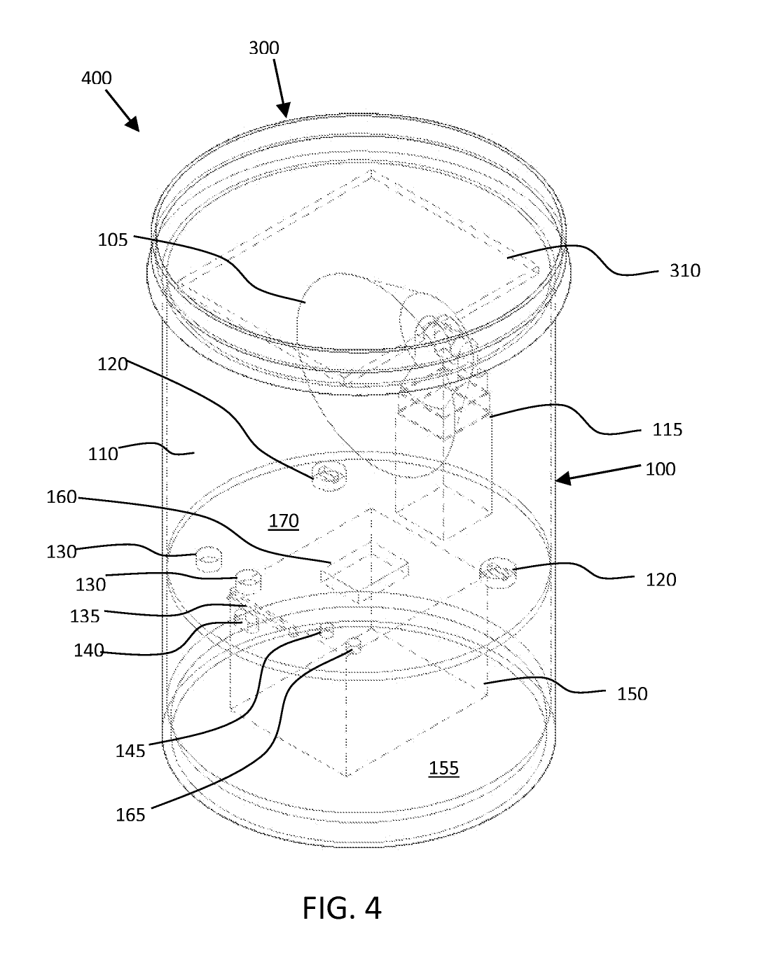

The power container 100 has a natural storage cavity 110 that is formed by the empty space between the top plate 170 and the lid 300, as shown in FIG. 4. The storage cavity 110 can be used to hold application specific devices and items. For example, instances of the invention could be customized for hurricane/flood emergencies and could contain vinyl rain gear, dehydrated food, drinking water, thermal blankets, a first aid kit and a radio. Another instance of the invention could be customized as a recreational boating emergency kit, and may contain dehydrated food, drinking water, thermal blankets, a first aid kit and a radio/strobe beacon tuned to the emergency Coast Guard channel. Another instance of the invention could be customized for long-term use and would not contain drinking water, but would instead contain a powered water purifier that could supply drinking/cooking water on a daily basis. This configuration would be useful in refugee camps that appear suddenly when conditions in their area of residence force them to leave without any time to prepare.

In the preferred embodiment of the invention, the power container 100 would have a carrying handle, not shown, that could be used to transport the container during deployment and after it has been deployed. In other embodiments of the invention, the power container 100 would be outfitted with straps to enable it to be carried like a backpack. In other embodiments of the invention, the power container 100 would be outfitted with a parachute to allow it to be air dropped to remote and otherwise inaccessible areas.

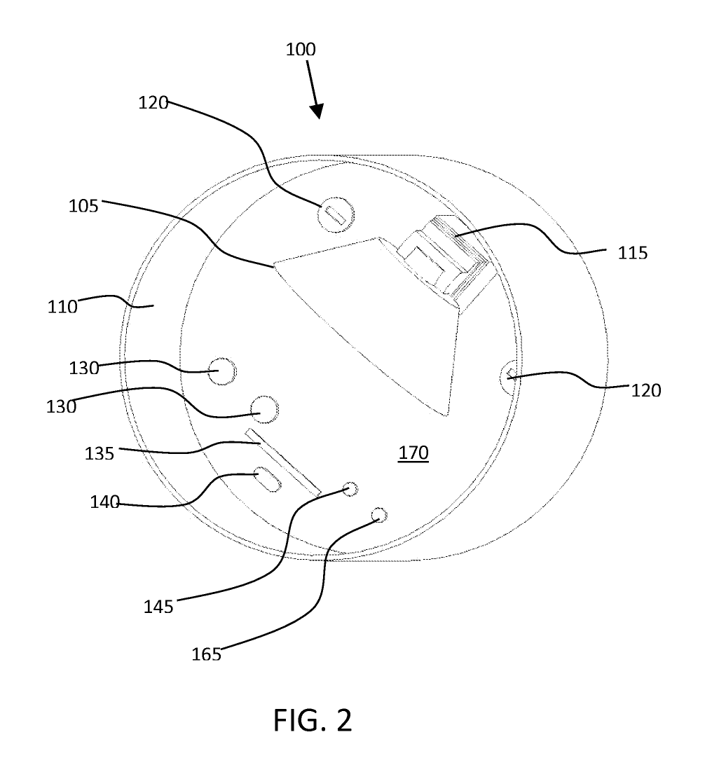

Referring to FIG. 2, which illustrates a top perspective view of the power container without the lid, the USB powered plugs 120, the main power on/off switch 140, the power jacks 130, the power reserve indicator 135, the extendable lamp arm 115, the lamp assembly 105, the push button switch 145 to increase the lamp intensity, the push button switch 165 to decrease the lamp intensity and the sealed top plate 170 are all visible.

In the preferred embodiment of the invention, the power container 100 can illuminate the lamp assembly 105 with the extendable lamp arm 115 in any position. The power container 100 is made of translucent material that acts as a light diffuser that allows the power container 100 to be used with the extendable lamp arm 115 in its fully retracted position and with the lid installed, causing it to appear and operate as a large lantern.

The main power on/off switch 140 is used to enable the functionality of the power container 100. The switch is used to completely disconnect the battery 150 from the circuit. Having the battery 150 completely isolated from the circuit gives a fully charged power container 100 the maximum shelf life. In other words, none of the power would be slowly bled off by the electronics module 160 while the unit was in storage waiting to be deployed.

The push button switch 145 would be used to increase the lamp intensity in situations where more light is required, while the push button switch 165 would be used to decrease the lamp intensity in situations where less light but longer periods of light are needed.

The USB powered plugs 120 would be used to charge cellphones, radios, etc.

The power reserve indicator 135 is a bar LED display that indicates the amount of charge remaining in the battery 150. Other techniques could be used to indicate the remaining charge, such as an LED that gradually changes from bright green (fully charged) to red (almost depleted).

The power jacks 130 have nearly a direct connection to the battery 150. Other than having short circuit and reverse polarity protection, they are essentially direct connections to the battery 150. This allows the power jacks 130 to be used to charge the battery 150 or drain the battery 150. If multiple power containers are connected together through their power jacks 130, they are effectively connecting their batteries in parallel. This action increases the power capacity of the power containers. For example, if two power containers are connected this way and only one has its lamp lit, then the lamp will stay illuminated for twice as long as a single power container operating alone. This arrangement can be used to power devices that require more power whose usefulness would be insufficient if powered by just one power container. In addition, this capability allows multiple solar panels 310 to be used to charge a power container 100.

In the preferred embodiment of the invention, the battery 150 is approximately 12 volts. Many devices are powered with 12 volts and this gives the power jacks 130 a more universal use. In other embodiments of the invention, higher or lower battery voltages are used and DC to DC converters are used to supply different voltages for external devices. In other embodiments of the invention, a DC to AC inverter is used to supply an AC jack that could be used to power AC devices.

In the preferred embodiment of the invention, the top plate 170 is sealed around its edge to provide a waterproof environment for the battery 150 and the electronics module 160. In addition, the switches, plugs, etc. installed in the top plate 170 are waterproof type devices. In another embodiment of the invention, the electronics module 160 is potted in a waterproof material and the battery 150 is sealed against moisture, eliminating the need for a waterproof environment in the lower chamber of the power container 100. Drainage holes would be provided in the top plate 170 and the bottom plate 155 to allow any accumulated moisture to escape.

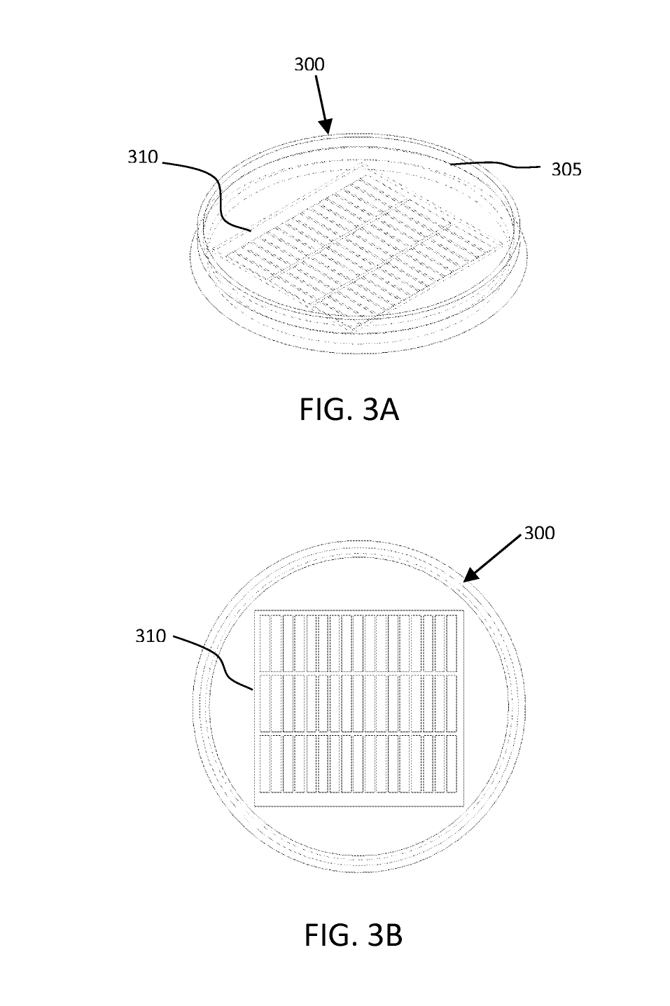

Referring to FIG. 3A, which illustrates a top perspective view of the power container lid, showing the hidden solar panel component, the main features of the lid 300 can be seen. The lid 300 has a shallow cavity 305 that is slightly larger than the bottom of the power container 100. This allows the power containers to be stacked during storage. The lid 300 would be attached to the power container 100 with a press fit sealed connection or a treaded connection. Aside from the various innovative features and capabilities of the power container 100, it resembles a five gallon paint container mechanically.

Referring to FIG. 3B, which illustrates a bottom perspective view of the power container lid, the solar panel component 310 is clearly seen. In the preferred embodiment of the invention, the solar panel 310 is attached to the underside of the lid 300 and is therefore protected from shock and mechanical damage while the power containers are being transported or deployed. In another embodiment of the invention, the solar panel 310 is simply stored in the storage cavity 110.

FIG. 4 shows the complete power container assembly 400 consisting of the power container 100 with a lid 300 installed. The handle and items normally stored in the storage cavity 110 are not shown in order to not obscure the illustration of the invention.

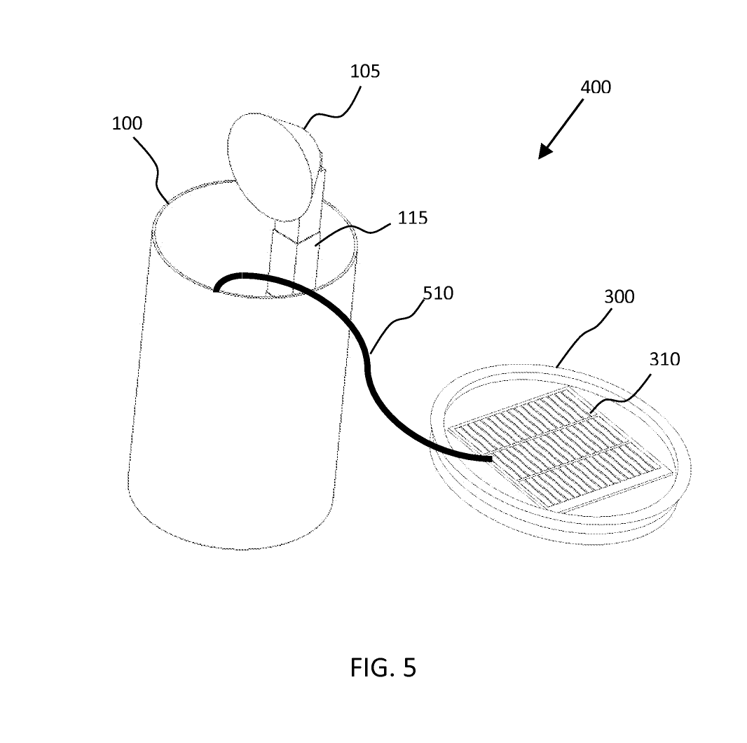

FIG. 5 shows the complete power container assembly 400 consisting of the power container 100 and a lid 300 in the deployed/charging position. The lamp assembly 105 is placed above the edge of the power container 100 by extending the extendable lamp arm 115. A power cable 510 connects the solar panel 310 to one of the power container's power jacks 130, enabling the solar panel 310 to charge the power container 100. The power cable 510 would be one of the items stored in the storage cavity 110 before deployment.

In view of the wide variety of permutations to the embodiments described herein, this detailed description is intended to be illustrative only, and should not be taken as limiting the scope of the invention. To illustrate, while operations have generally been described with reference to disaster relief devices, embodiments are not so limited. For example, in an embodiment, the functionality of solar rechargeable power containers containing a light source can be used on a daily basis where a residential power infrastructure is not present. Therefore, the specification and drawings are to be regarded in an illustrative rather than a restrictive sense.

I claim:

1. A rechargeable power container device comprising:
a container with a removable lid;
a storage cavity;
a rechargeable battery;
an electrically powered light source;
a number of power networking connectors for powering auxiliary devices;
a number of USB connectors for powering and recharging portable USB devices;
a means for controlling the intensity of said electrically powered light source;
a means for indicating the amount of power left in said rechargeable battery and a means for connecting multiple power containers together.

2. The device of claim 1, wherein said electrically powered light source is attached to an extendable arm.

3. The device of claim 1, wherein said rechargeable battery is charged via a solar panel attached to the underside of said lid.

4. The device of claim 1, wherein said storage cavity is used to configure the device for specific applications.

5. A rechargeable power container device comprising:
a translucent container with a removable lid;
a storage cavity;
a rechargeable battery;
an electrically powered light source;
a number of power networking connectors for powering auxiliary devices;
a number of USB connectors for powering and recharging portable USB devices;
a means for controlling the intensity of said electrically powered light source;
a means for indicating the amount of power left in said rechargeable battery and a means for connecting multiple power containers together.

6. The device of claim 5, wherein said electrically powered light source is attached to an extendable arm.

7. The device of claim 5, wherein said rechargeable battery is charged via a solar panel attached to the underside of said lid.

8. The device of claim 5, wherein said storage cavity is used to configure the device for specific applications.
